(19) United States
(12) Patent Application Publication
(10) Pub. No.: US 2005/0268863 A1
(43) Pub. Date: Dec. 8, 2005

(54) Pet vehicle safety restraint

(76) Inventor: Ruth Shaw Wiley, Orlando, FL (US)

Correspondence Address: RUTH SHAW WILEY, 21600 KING HENRY AVENUE, LEESBURG, FL, 34748, US

(21) Appl. No.: 10/862,587

(22) Filed: Jun. 7, 2004

(51) Int. Cl. B60R 22/00

(52) U.S. Cl. 119/771

(57) ABSTRACT

One preferred embodiment of the present invention includes a one-piece rigid 90 degrees frame base placed atop the vehicle seat. The base frame has restraining belt openings defined in the frame base. The base frame has an attachment point centrally located in the vertical portion of the base frame allowing the adjustable leash to loop through and span the distance to the harness loop. In the event of an accident the pet is stablilized.

### BACKGROUND OF THE INVENTION

The invention exalts simplicity of design for restraining pets during vehicle transport.

An object of the invention is to provide safety to the pet, the vehicle occupants, pedestrians, and other vehicles.

An object of the invention is to prevent motor vehicle accidents by avoiding distractions.

The invention is directed to preventing damage to vehicle seats.

### FIELD OF INVENTION

The invention relates to generally transporting pets safely in vehicles, protecting the pet, the passengers, and the vehicle car seat.

### DESCRIPTION OF PRIOR ART

It is known the need for pet vehicle safety restraints. Some pet booster seats and restraint systems have been taught or suggested in the prior art without providing all of the benefits and advantages of the present invention.

### SUMMARY OF THE INVENTION

The above objectives are accomplished according to the present invention.

Objects and advantages of the invention are apparent in the description taken in conjunction with the accompanying drawings set forth, by way of illustration and example, certain embodiments of the invention.

The purpose of the attached comparative analysis chart is to distinguish what is unique of The invention and that the structural feature of the one-piece rigid 90 degrees angle base frame formed of resilient plastic and the multiple strips of durable synthetic overlapping adhesive ends which form the harness as well as the leash, and the multiple adhesive sleeves formed of fibrous materials of the padded sleeves are not found in the other references cited and would not be an obvious combination of the cited references and prior art.

### DESCRIPTION OF DRAWINGS

The accompanying drawings describe the new design for an Improved Vehicle Pet Safety Restraint as set forth in the description. The invention will be more readily understood from a reading of the following specification:

FIG. 1 is a perspective view of the one piece 90 degrees base frame illustrating where the vehicle seat belt secures the molded base flesh against the vehicle seat in accordance with the invention;

FIG. 2 is a perspective view illustrating the leash attached to the base frame loop spanning the distance to the harness loop;

FIG. 3 is a perspective view illustrating the leash attached to the harness loop spanning the distance to the base frame loop;

FIG. 4 is a frontal view illustrating the harness constructed in accordance with the invention;

FIG. 5 is a sectional view of a padded sleeve that encases the harness constructed in accordance with the invention.

### DESCRIPTION OF THE PREFERRED EMBODIMENT

With reference to the drawings, an Improved Pet Vehicle Safety Restraint embodying the principles and concepts of the present invention will be described

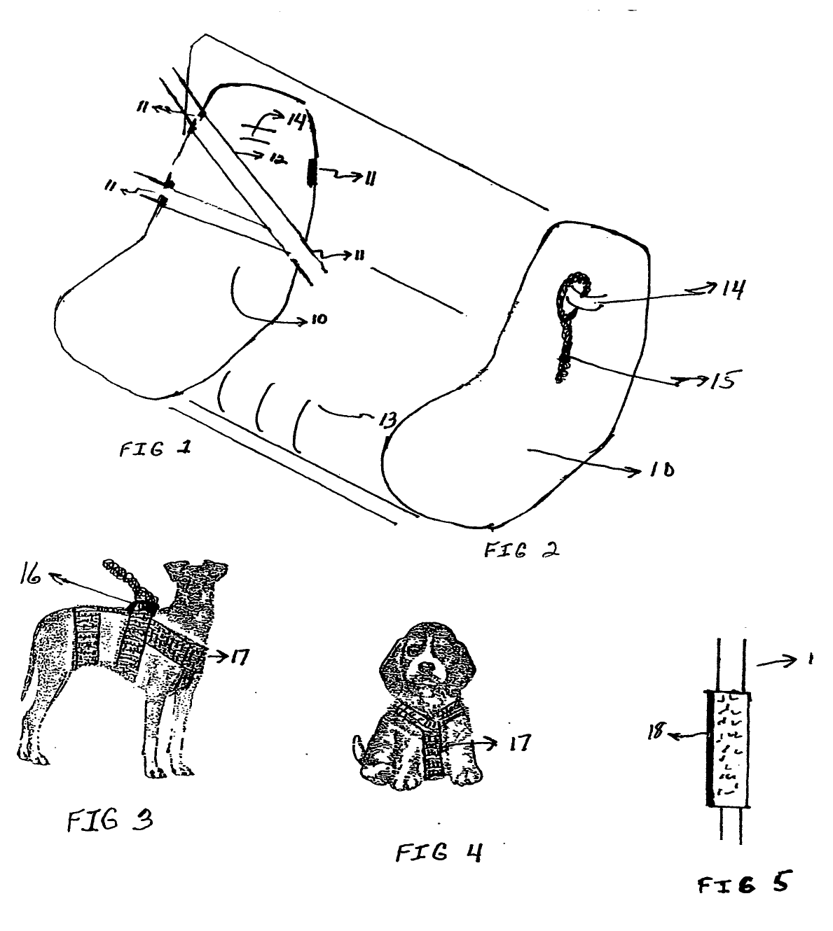

Turning to FIGS. 1-5, there is shown an exemplary embodiment of the Improved Pet Vehicle Safety Restraint designated by reference numeral 10. In its preferred form, the Improved Pet Vehicle Safety Restraint 10 includes a rigid one-piece 90 degrees base frame. The base frame 10 is formed of a resilient plastic. The base frame contains four inserts 11 where the vehicle seatbelts 12 slip through securing the base to the vehicle seat 13. The vertical portion of 10 includes a centralized loop 14 formed of the same resilient plastic of 10. The leash 15 spans the distance between the base loop 14 and 16 the harness loop. The fabric material of the leash 15, the harness loop 16 and the harness 17 may be formed of natural or synthetic fiber in whole or in part, and may be woven or knitted unattached multiple adhesive straps. The padded sleeves 18 encase the harness. The padded sleeves 18 may be formed of natural or synthetic fibrous materials in whole or in part, and may be woven, knitted, etc.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1-3. (canceled)

4. a one-piece rigid 90 degrees angle base formed of resilient plastic wherein said base frame is adapted to sit flesh atop and vertically adjacent to the vehicle seat;

5. an adjustable leash formed of natural or synthetic fiber adjusted by overlapping adhesive ends;

6. the harness consists of multiple unattached strips of durable natural or synthetic fiber adjusted by overlapping adhesive ends covered with padded adjustable and unattached multiple adhesive sleeves and straps formed of fibrous materials.
